(19) United States
(12) Patent Application Publication
(10) Pub. No.: US 2026/0167132 A1
(43) Pub. Date: Jun. 18, 2026

(54) AGGREGATION BOX AND IN-VEHICLE SYSTEM

(71) Applicant: YAZAKI CORPORATION, Tokyo (JP)

(72) Inventors: Yohei Uchida, Susono-shi (JP); You Yanagida, Susono-shi (JP); Mirei Hosoki, Susono-shi (JP); Shingo Suzuki, Susono-shi (JP)

(21) Appl. No.: 19/387,478

(22) Filed: Nov. 12, 2025

(30) Foreign Application Priority Data
Nov. 13, 2024 (JP) 2024-198456

(51) Int. Cl. B60R 16/023

(52) U.S. Cl. CPC B60R 16/0238; B60R 16/0239

(57) ABSTRACT

An aggregation box is provided between an ECU and a power source, which are mounted on a vehicle, and a terminal device, relays data exchanged between the ECU and the terminal device, and supplies electric power supplied from the power source to the terminal device. The aggregation box includes a power source unit that switches a voltage value of the electric power supplied from the power source according to input voltage specifications of the terminal device to be connected, and supplies the electric power to the terminal device. Further, the aggregation box includes a control unit that relays the data and controls switching of a voltage value in the power source unit. Moreover, the aggregation box includes a connection connector for connecting to the other aggregation box, the connection connector including signal terminals for transmitting and receiving the data and power source terminals for supplying the electric power.

### CROSS-REFERENCE TO RELATED APPLICATIONS

The present application is based on, and claims priority from the Japanese Patent Application No. 2024-198456, filed on Nov. 13, 2024, the entire contents of which are incorporated herein by reference.

### TECHNICAL FIELD

The present disclosure relates to an aggregation box and an in-vehicle system.

### BACKGROUND

Conventionally, a technology for coping with the change or addition of in-vehicle devices mounted on vehicles has been proposed. JP2022-112837 discloses an in-vehicle communication system capable of coping with the change or expansion of in-vehicle devices mounted on vehicles without changing the hardware configuration of in-vehicle control devices. In the in-vehicle communication system disclosed in JP2022-112837, an FPGA (Field Programmable Gate Array) that changes a connection path enables the addition of devices corresponding to multiple types of communication protocols.

### SUMMARY OF THE INVENTION

Devices mounted on vehicles have various functions, and values of required input voltages also vary according to the functions. For example, in the in-vehicle communication system disclosed in JP2022-112837, the devices can be added for multiple types of communication protocols, but it is difficult to cope with the addition of in-vehicle devices having different input voltages. Therefore, there is a need for a technology with which it is possible to flexibly add in-vehicle devices having input voltages that are not anticipated at the time of vehicle sale.

The present disclosure has been made in view of such problems of the conventional technology. An object of the present disclosure is to provide an aggregation box in which in-vehicle devices not anticipated at the time of vehicle sale can be easily added.

An aggregation box according to an aspect of the present disclosure is provided between an ECU and a power source, which are mounted on a vehicle, and a terminal device, relays data exchanged between the ECU and the terminal device, and supplies electric power supplied from the power source to the terminal device, and includes: a power source unit that switches a voltage value of the electric power supplied from the power source according to input voltage specifications of the terminal device to be connected, and supplies the electric power to the terminal device; a control unit that relays the data and controls switching of a voltage value in the power source unit; and a connection connector for connecting to the other aggregation box, the connection connector including signal terminals for transmitting and receiving the data and power source terminals for supplying the electric power.

An in-vehicle system according to another aspect of the present disclosure includes: the ECU mounted on a vehicle; the power source mounted on the vehicle; the terminal device mounted on the vehicle; and the above aggregation box that is provided between the ECU and the power source, and the terminal device, relays the data exchanged between the ECU and the terminal device, and supplies the electric power supplied from the power source to the terminal device.

According to the present disclosure, it is possible to provide an aggregation box in which in-vehicle devices not anticipated at the time of vehicle sale can be easily added.

### BRIEF DESCRIPTION OF DRAWINGS

FIG. 1 is a diagram illustrating the configuration of an in-vehicle system according to the present embodiment.

FIG. 2 is a diagram illustrating a configuration example of the in-vehicle system according to the present embodiment.

FIG. 3 is a block diagram illustrating the configuration of an aggregation box according to the present embodiment.

FIG. 4A is a diagram for explaining a determination function of the aggregation box according to the present embodiment.

FIG. 4B is a diagram for explaining the determination function of the aggregation box according to the present embodiment.

FIG. 5A is a diagram for explaining the determination function of the aggregation box according to the present embodiment.

FIG. 5B is a diagram for explaining the determination function of the aggregation box according to the present embodiment.

FIG. 6 is a diagram for explaining the configuration of the in-vehicle system according to the present embodiment.

FIG. 7 is a diagram for explaining the configuration of the aggregation box according to the present embodiment.

FIG. 8 is a diagram for explaining the configuration of the aggregation box according to the present embodiment.

FIG. 9A is a diagram for explaining a connection example of the aggregation box according to the present embodiment.

FIG. 9B is a diagram for explaining a connection example of the aggregation box according to the present embodiment.

FIG. 10A is a diagram for explaining a connection example of the aggregation box according to the present embodiment.

FIG. 10B is a diagram for explaining a connection example of the aggregation box according to the present embodiment.

FIG. 11A is a diagram for explaining a connection example of the aggregation box according to the present embodiment.

FIG. 11B is a diagram for explaining a connection example of the aggregation box according to the present embodiment.

FIG. 12A is a diagram for explaining a connection example of the aggregation box according to the present embodiment.

FIG. 12B is a diagram for explaining a connection example of the aggregation box according to the present embodiment.

FIG. 13A is a diagram for explaining a connection example of the aggregation box according to the present embodiment.

FIG. 13B is a diagram for explaining a connection example of the aggregation box according to the present embodiment.

FIG. 14A is a diagram for explaining the configuration of a comparative example of an in-vehicle system.

FIG. 14B is a diagram for explaining the configuration of the in-vehicle system according to the present embodiment.

FIG. 15A is a diagram for explaining connection determination of a terminal device in the aggregation box according to the present embodiment.

FIG. 15B is a diagram for explaining connection determination of the terminal device in the aggregation box according to the present embodiment.

FIG. 16 is a diagram for explaining facility update in the in-vehicle system according to the present embodiment.

FIG. 17 is a sequence diagram for explaining communication and electric power supply in the in-vehicle system according to the present embodiment.

FIG. 18 is a diagram for explaining facility update in the in-vehicle system according to the present embodiment.

FIG. 19A is a diagram for explaining a case of the aggregation box according to the present embodiment.

FIG. 19B is a diagram for explaining a cover of the aggregation box according to the present embodiment.

FIG. 19C is a diagram for explaining the case and the cover of the aggregation box according to the present embodiment.

FIG. 20 is a diagram for explaining the TPMS applied to an in-vehicle system according to the present embodiment.

FIG. 21A is a diagram for explaining the TPMS applied to an in-vehicle system according to the present embodiment.

FIG. 21B is a diagram for explaining the TPMS applied to an in-vehicle system according to the present embodiment.

FIG. 22A is a diagram for explaining the TPMS applied to an in-vehicle system according to the present embodiment.

FIG. 22B is a diagram for explaining the TPMS applied to an in-vehicle system according to the present embodiment.

FIG. 23 is a diagram for explaining a driver authentication system applied to the in-vehicle system according to the present embodiment.

### DETAILED DESCRIPTION OF THE INVENTION

Hereinafter, an aggregation box 100 and an in-vehicle system 10 according to the present embodiment will be described in detail with reference to the drawings. The dimensional ratios in the drawings are exaggerated for the sake of explanation and may differ from the actual ratios. In the following drawings, identical or similar parts are denoted by identical or similar reference numerals.

### Configuration of In-Vehicle System 10

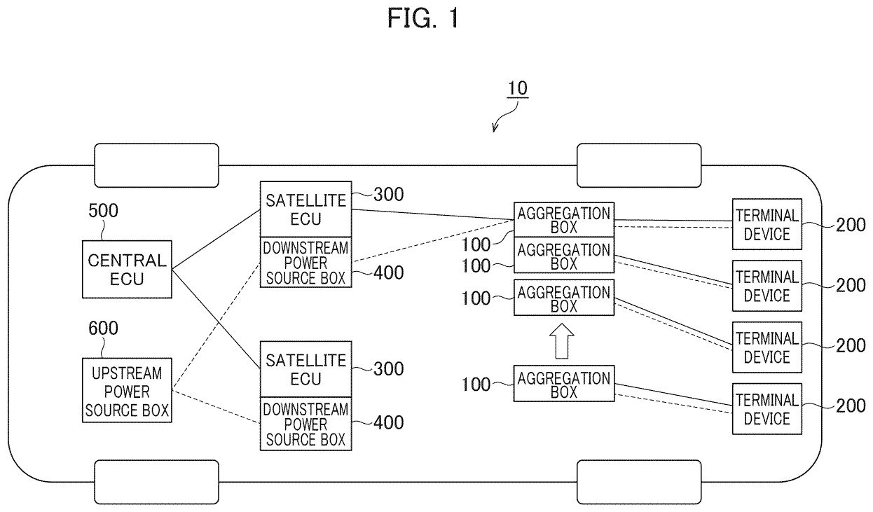

FIG. 1 is a diagram illustrating the configuration of the in-vehicle system 10 according to the present embodiment. The in-vehicle system 10 includes an aggregation box 100, a terminal device 200, a satellite ECU 300, and a downstream power source box 400. The in-vehicle system 10 may further include a central ECU 500 and/or an upstream power source box 600. Note that the aggregation box 100, the downstream power source box 400, and the upstream power source box 600 correspond to the aggregation box, the downstream power source box, and the upstream power source box illustrated in FIG, respectively.

In the example illustrated in FIG. 1, the signal lines for transmitting and receiving data are illustrated by solid lines, and the power source lines for supplying electric power are illustrated by broken lines. In addition, in the following drawings, unless otherwise mentioned, the signal lines for transmitting and receiving data are illustrated by solid lines, and the power source lines for supplying electric power are illustrated by broken lines.

The aggregation box 100 is provided between an ECU and a power source, which are mounted on a vehicle, and the terminal device 200. In the example illustrated in FIG. 1, the ECU connected to the aggregation box 100 corresponds to the satellite ECU 300. Further, in the example illustrated in FIG. 1, the power source connected to the aggregation box 100 corresponds to the downstream power source box 400.

The aggregation box 100 relays data that is exchanged between the ECU and the terminal device 200. In addition, the aggregation box 100 supplies electric power supplied from the power source to the terminal device 200.

The terminal device 200 is an in-vehicle device mounted on a vehicle, and corresponds to, for example, a motor, a light emitting diode (LED), a sensor, and an electronic control unit (ECU).

The terminal device 200 will now be described in detail. In the terminal device 200, there are (1) devices and parts that may be replaced, and (2) devices and parts that should not be replaced to the extent possible, when the vehicle is used for a long time. For example, (1) devices and parts that may be replaced include LiDAR with significantly improved detection accuracy that cannot be handled by software updates alone, and consumable parts.

In addition, (2) devices and parts that should not be replaced to the extent possible include ECUs such as the central ECU 500 and wire harnesses (W/H). Since these devices are not intended to be replaced, they are typically fixed in a place where replacement is difficult.

However, when devices are added, a wired connection is required depending on the installation location and installation method, and in this case, reconnection of the W/H and devices is required. In the reserve design that can be anticipated at the time of vehicle sale, which anticipates the addition of devices, connection ports for connecting the W/H and devices are provided in a zone ECU and the like.

In contrast, when devices not anticipated at the time of vehicle sale are connected, there are situations where connection ports for additional devices are not provided or the number of connection ports is insufficient. Therefore, in the in-vehicle system 10 according to the present embodiment, a load (terminal device 200) is connected from the satellite ECU 300 via the aggregation box 100, thereby enabling flexible response to equipment update.

The satellite ECU 300 is also called a zone ECU or an area ECU, and is positioned, for example, in each of multiple areas at the front, rear, left, and right of the vehicle.

The downstream power source box 400 is a device for supplying electric power to the aggregation box 100 and the terminal device 200.

The central ECU 500 is an ECU for aggregating control functions of multiple systems. Note that, in the present embodiment, the central ECU 500 is not an essential component, and the vehicle may be controlled by the satellite ECU 300 alone.

The upstream power source box 600 corresponds to a battery, for example, and supplies electric power to the downstream power source box 400 via a DC/DC converter or a battery fuse terminal (BFT).

Here, the wiring used in the in-vehicle system 10 will be described. For wiring that is desired to be used for a long time without replacement, it is desirable to use conductive paths with long life and high durability, and such wiring is typically often routed in locations where replacement is difficult.

In addition, the wiring may have a shielding function depending on the section, or flat cable routing materials (for example, FFC: Flexible Flat Cable) may be used. Various cable routing materials may be designed according to the connected load at the time of vehicle sale. Note that, in vehicles with reserved design specifications, various cable routing materials are designed according to loads that may be connected, but generally they are not replaced after vehicle sale except for repairs.

Therefore, in conventional vehicles without reserved design specifications, it is necessary to replace cable routing materials for adding functions, but in the in-vehicle system 10 according to the present embodiment, by using the aggregation box 100, it is possible to reduce replacement, removal, and addition of cable routing materials.

The electric wires that connect the aggregation box 100 and the terminal device 200 are replaced together with the aggregation box 100 and the terminal device 200. The types of the electric wires that connect the aggregation box 100 and the terminal device 200 are determined according to the type of the terminal device 200 and the wire length.

In addition, the aggregation box 100 separates electric wires for signals and power source, but input and output may be consolidated into one aggregation box. At the time of vehicle sale, at least one aggregation box 100 is mounted. Further, although multiple aggregation boxes 100 are connected to the satellite ECU 300 as illustrated in FIG. 1, the aggregation box 100 may not be connected to the satellite ECU 300 or the like to which devices are not added, in order to ensure security.

Further, when the aggregation box 100 is additionally connected, electric power may be supplied to the additional aggregation box 100 by non-contact power feeding. Moreover, communication does not necessarily need to be performed by wire, but may be performed by radio. In this case, it is desirable to provide the satellite ECU 300 with a transceiver capable of radio communication with the terminal device 200 that is added.

Further, the aggregation box 100 is positioned closer to where the terminal device 200 is attached than the satellite ECU 300. That is, the wire length between the aggregation box 100 and the terminal device 200 is shorter than the wire length between the satellite ECU 300 and the aggregation box 100.

Note that for the connection between the satellite ECU 300 and the aggregation box 100, which has a long wire length, it is desirable to reduce the weight and use relatively lightweight materials such as an aluminum electric wire or an aluminum bus bar. In contrast, for the connection between the aggregation box 100 and the terminal device 200, which has a short wire length, it is desirable to reduce the size and the height in consideration of the possibility that the number of electric wires may increase due to the addition of the terminal device 200, and to use cable routing materials with good routing workability such as a copper electric wire or an FFC.

In addition, since it is expected that the electric wires between the satellite ECU 300 and the aggregation box 100 will be used for a long period of time, it is preferable to use electric wires made from non-recycled materials. In contrast, since the electric wires between the aggregation box 100 and the terminal device 200 have a short wire length and can be replaced, it is preferable to use electric wires made from recycled materials. For example, in terms of resistance values and durability, the quality of recycled materials tend to be lower than that of non-recycled materials. Note that the electric wires of the vehicle may be composed entirely of non-recycled electric wires, or may be composed entirely of recycled electric wires.

That is, in the in-vehicle system 10, the satellite ECU 300 and the aggregation box 100, and the aggregation box 100 and the terminal device 200 may be connected by a cylindrical or flat cable routing material, an optical fiber, a coaxial cable, or a cable routing material formed of a balanced communication cable.

Further, in the in-vehicle system 10 according to the present embodiment, the wire length of the cable routing material used for connecting the satellite ECU 300 and the aggregation box 100 may be longer than the wire length of the cable routing material used for connecting the aggregation box 100 and the terminal device 200. Thus, the in-vehicle system 10 can reduce the amount of the cable routing material to be replaced in the attachment of the terminal device 200.

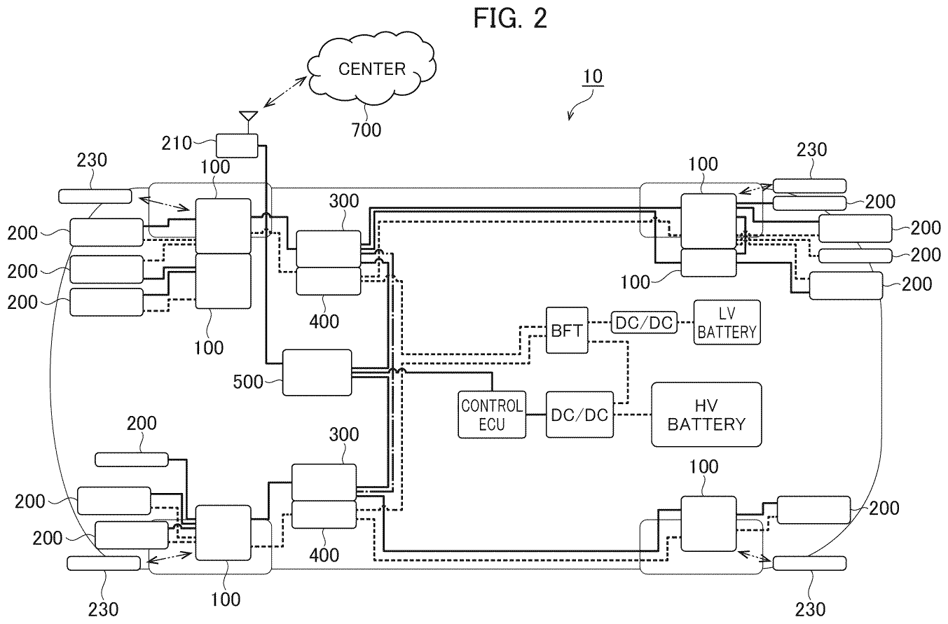

FIG. 2 is a schematic diagram illustrating a configuration example of the in-vehicle system 10 according to the present embodiment. The central ECU 500 is provided at the vehicle center front and is connected to the respective satellite ECUs 300 positioned on the left and right sides of the vehicle. In addition, each of the satellite ECUs 300 is connected to the aggregation boxes 100 at the front and rear by signal lines.

Similarly, the LV battery and the HV battery that are positioned at the vehicle center rear are connected to the respective downstream power source boxes 400 via a DC/DC converter and a BFT. The respective downstream power source boxes 400 are connected to the aggregation boxes 100 at the front and rear by power source lines.

Further, in the example illustrated in FIG. 2, a tire pressure monitoring system (TPMS) 230 with a power generation function, which is a terminal provided with a generator and/or a battery, is illustrated as the terminal device 200. FIG. 2 also illustrates a telematics control unit (TCU 210) that realizes communication between the vehicle and a center 700. The details of the TPMS 230 and the TCU 210 will be described later.

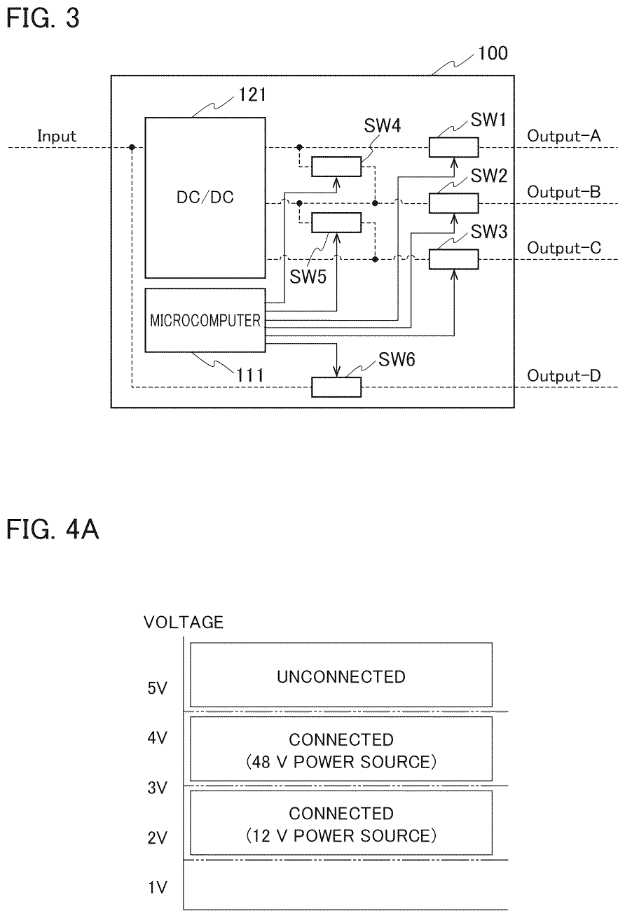

FIG. 3 is a block diagram illustrating the configuration of the aggregation box 100 according to the present embodiment. The aggregation box 100 illustrated in FIG. 3 includes multiple connection destinations (Output-A to Output-D) to which the terminal devices 200 are connected. Further, the aggregation box 100 illustrated in FIG. 3 can output the electric power that is output directly from the DC/DC converter 121 by ON and OFF combinations of SW1 to SW6 (ON: SW1 to 3, 6, OFF: SW4 and 5). Moreover, by the ON and OFF combinations of SW1 to SW6, the electric power can be output with increased current capacity (ON: SW1, 4, OFF: SW2, 3, 5).

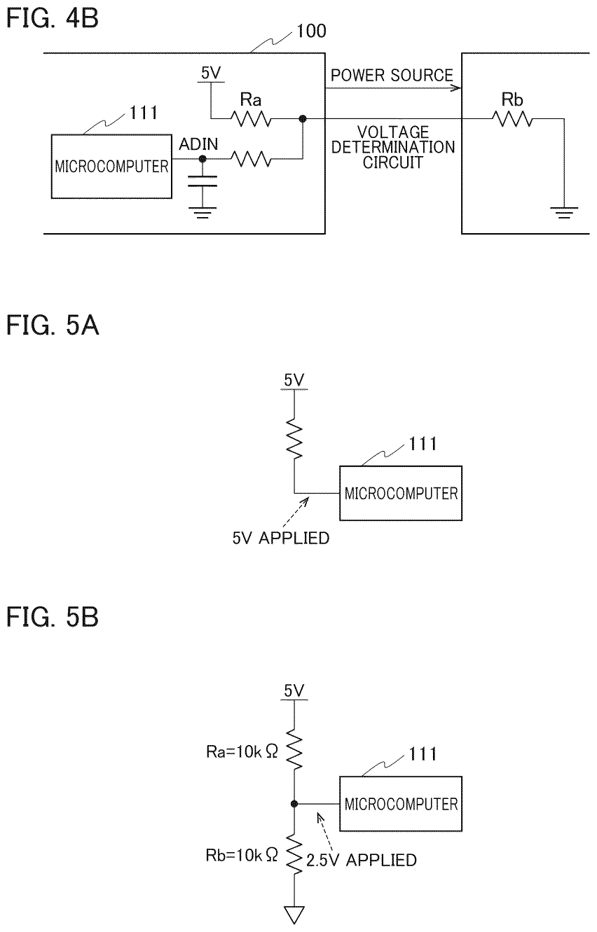

Further, when a load (terminal device 200) is connected, the aggregation box 100 can automatically determine the connection state and the connected load (12 V or 48 V) by confirming a predetermined resistance ratio and supply electric power accordingly. FIGS. 4A to 5B are diagrams for explaining the determination function of the aggregation box 100 according to the present embodiment. In the present specification, 12 V and 48 V power supplies are illustrated as voltages of electric power to be supplied, but the power source voltages are not limited thereto, and other voltages may be applied according to specifications.

For example, when a voltage of 5 V or more is detected in FIG. 4A, the microcomputer 111 of the aggregation box 100 determines that the load is unconnected. Further, when a voltage of 3 V or more and less than 4 V is detected, the microcomputer 111 determines that the load of the 48 V power source is connected. Further, when a voltage of 2 V or more and less than 3 V is detected, the microcomputer 111 determines that the load of the 12 V power source is connected.

The determination made by the microcomputer 111 is performed by changing the voltage input to the microcomputer 111 according to the voltage dividing ratio of the resistor Ra and the resistor Rb illustrated in FIG. 4B. For example, as illustrated in FIG. 5A, since a voltage of 5 V is applied to the microcomputer 111, the microcomputer 111 determines that the load is unconnected. In contrast, as illustrated in FIG. 5B, since a voltage of 2.5 V is applied to the microcomputer 111 by dividing the voltage, the microcomputer 111 detects that the load is connected and connects the 12 V power source.

### Connection example of aggregation box 100

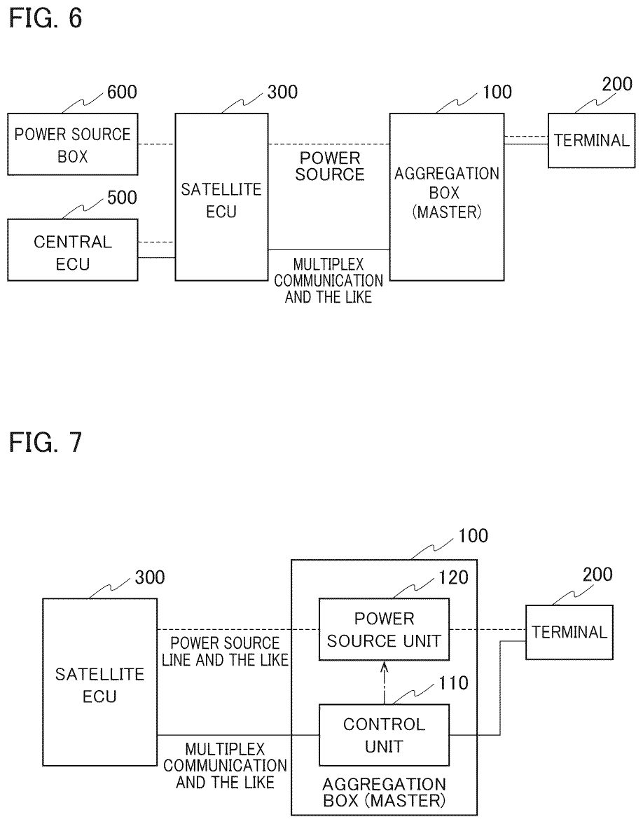

Next, a connection example of the aggregation box 100 will be described. FIG. 6 is a diagram for explaining the configuration of the in-vehicle system 10 according to the present embodiment. FIG. 7 is a diagram for explaining the configuration of the aggregation box 100 according to the present embodiment. As illustrated in FIGS. 6 and 7, the aggregation box 100 is connected to the satellite ECU 300 by a W/H and has a configuration that allows one aggregation box to be added for each terminal.

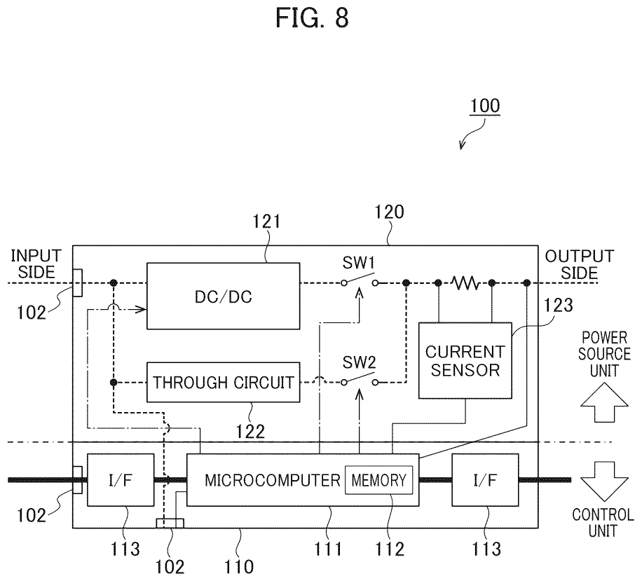

FIG. 8 is a diagram for explaining the configuration of the aggregation box 100 according to the present embodiment. The aggregation box 100 includes a power source unit 120 that switches a voltage value of the electric power supplied from the power source according to the input voltage specifications of the terminal device 200 to be connected, and supplies the electric power to the terminal device 200. Further, the aggregation box 100 includes a control unit 110 that relays data and controls switching of a voltage value in the power source unit 120.

The power source unit 120 includes a DC/DC converter 121, a through circuit 122, and a current sensor 123. The control unit 110 includes the microcomputer 111, a memory 112, and an interface 113 (I/F).

The microcomputer 111 controls the DC/DC converter 121, the switch SW1, and/or the switch SW2 in response to input fluctuations of the terminal device 200 that is connected to the output side, thereby supplying a stable voltage.

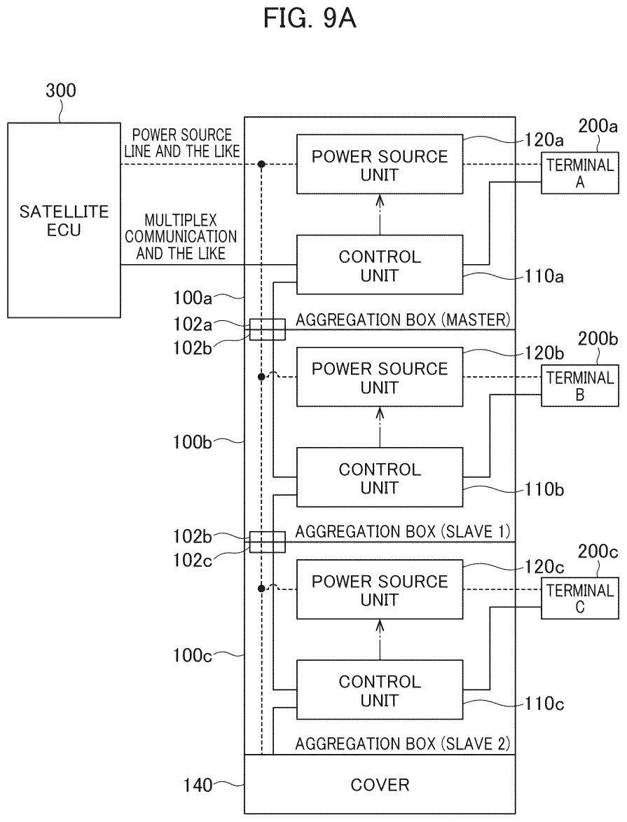

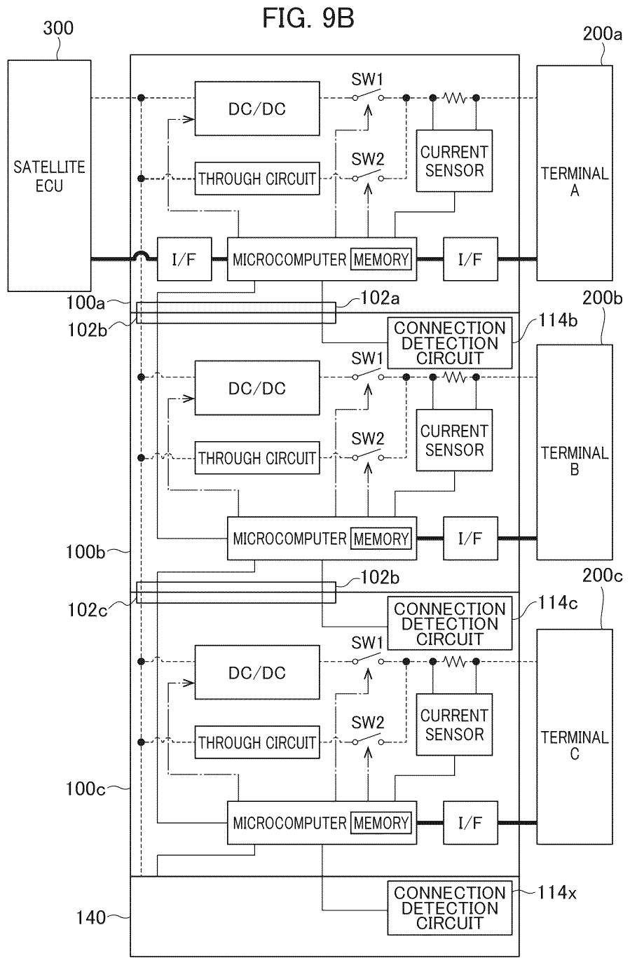

FIGS. 9A and 9B are diagrams for explaining a connection example of the aggregation box 100 according to the present embodiment. The examples illustrated in FIGS. 9A and 9B show an example in which the aggregation box 100 is daisy-chained. As illustrated in FIGS. 9A and 9B, the aggregation boxes 100a and 100b are connected to each other via the connection connectors 102a and 102b. Similarly, the aggregation boxes 100b and 100c are connected to each other via the connection connectors 102b and 102c. That is, the aggregation box 100 includes a connection connector 102 for connecting to another aggregation box 100, the connection connector 102 including signal terminals for transmitting and receiving the data and power source terminals for supplying the electric power. As illustrated in FIG. 9B, the aggregation boxes 100b and 100c, and the cover 140 include the connection detection circuits 114b, 114c, and 114x that detect whether they are connected to the aggregation box 100a, the aggregation box 100b, and the aggregation box 100c, respectively.

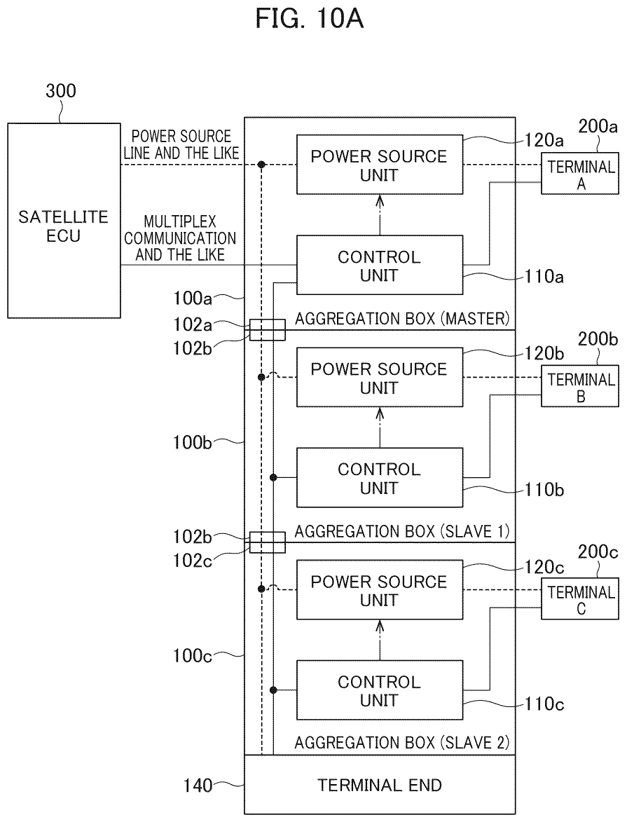

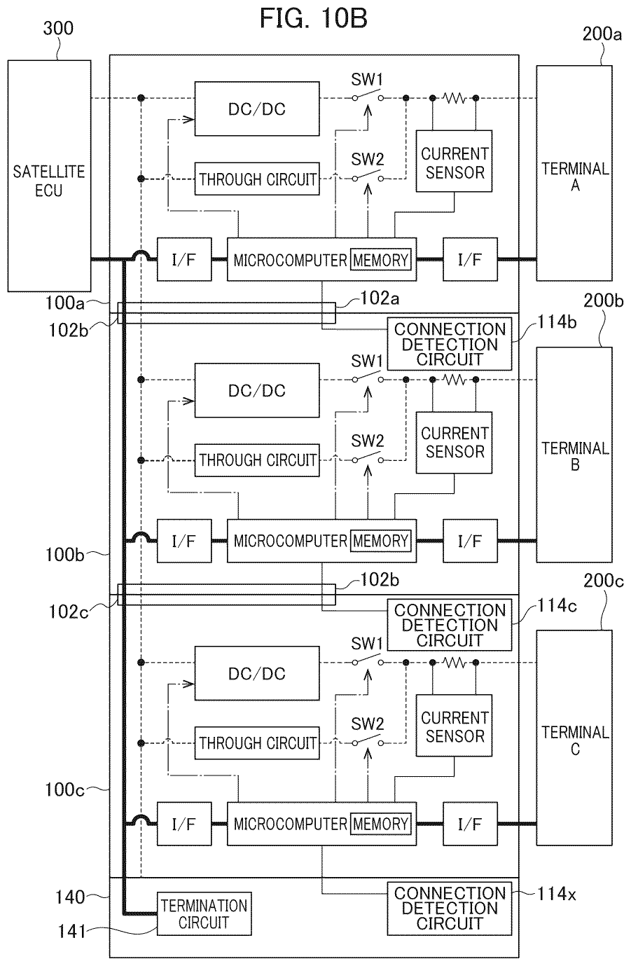

FIGS. 10A and 10B are diagrams for explaining another connection example of the aggregation box 100 according to the present embodiment. The examples illustrated in FIGS. 10A and 10B show an example in which the aggregation box 100 is bus-connected. As illustrated in FIGS. 10A and 10B, the aggregation boxes 100a and 100b are connected to each other via the connection connectors 102a and 102b. Similarly, the aggregation boxes 100b and 100c are connected to each other via the connection connectors 102b and 102c. As in the case of the daisy chain connection described above, the aggregation box 100 includes the connection connector 102 for connecting to another aggregation box 100, the connection connector 102 including signal terminals for transmitting and receiving the data and power source terminals for supplying the electric power. As illustrated in FIG. 10B, the aggregation box 100b, the aggregation box 100c, and the cover 140 include the connection detection circuits 114b, 114c, and 114x that detect whether they are connected to the aggregation box 100a, the aggregation box 100b, and the aggregation box 100c, respectively. Further, the examples illustrated in FIGS. 10A and 10B are applied to a case where the in-vehicle network is a controller area network (CAN), for example.

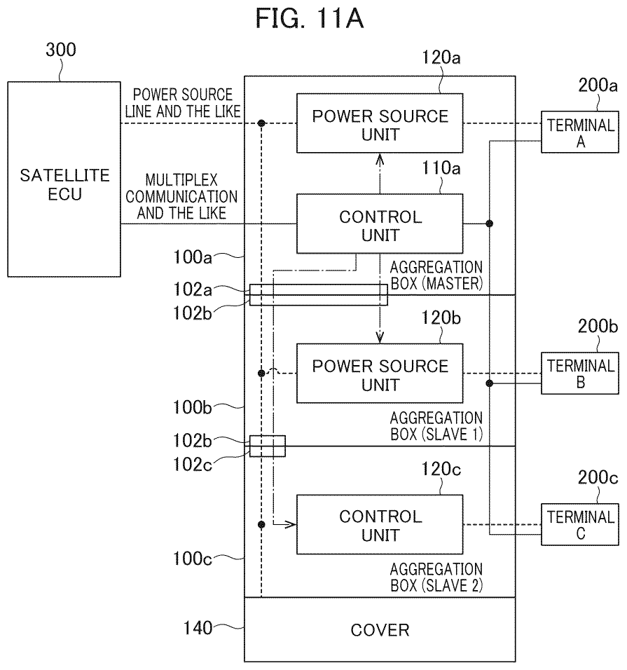

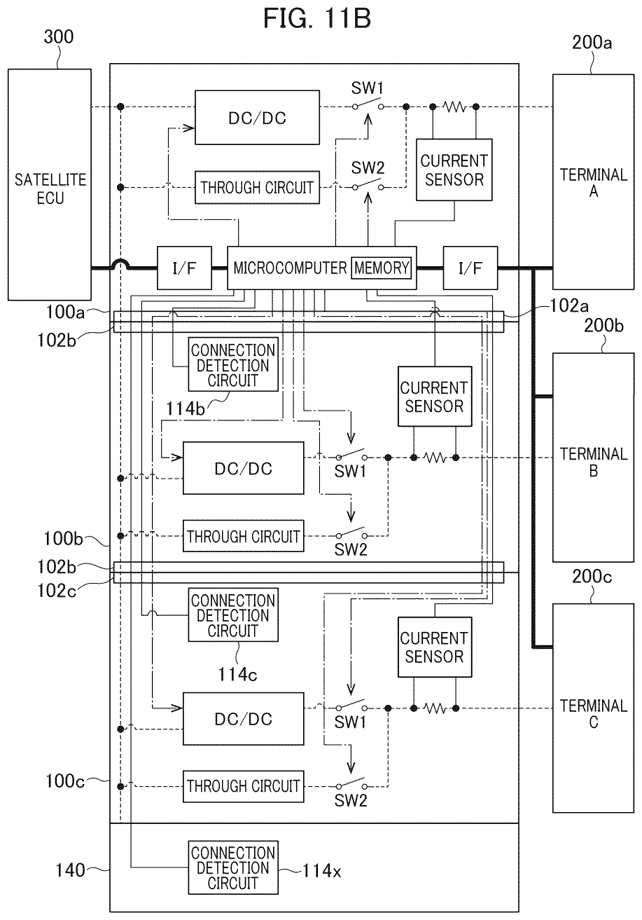

FIGS. 11A and 11B are diagrams for explaining another connection example of the aggregation box 100 according to the present embodiment. In the examples illustrated in FIGS. 11A and 11B, only the aggregation box 100a serving as a master includes a control unit 110a, and the aggregation box 100b and the aggregation box 100c serving as the slave 1 and the slave 2 operate in accordance with instructions from the control unit 110a. As illustrated in FIG. 11B, the aggregation box 100b, the aggregation box 100c, and the cover 140 include the connection detection circuits 114b, 114c, and 114x that detect whether they are connected to the aggregation box 100a, the aggregation box 100b, and the aggregation box 100c, respectively.

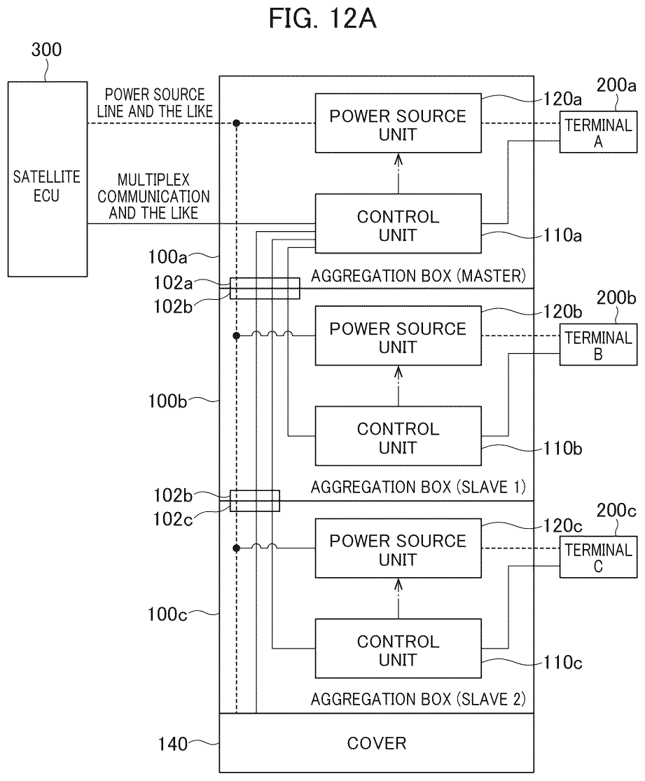

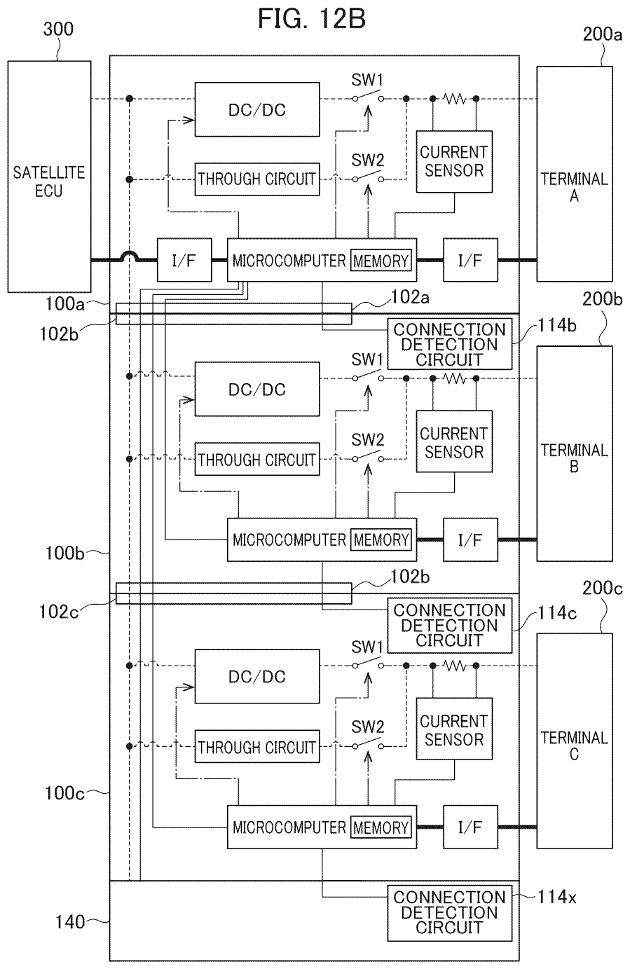

FIGS. 12A and 12B are diagrams for explaining another connection example of the aggregation box 100 according to the present embodiment. In the examples illustrated in FIGS. 12A and 12B, the control unit 110a of the aggregation box 100a serving as a master can communicate with the other control units 110b and 110c individually. Note that the communication may be wired not only within the substrate but also through wiring outside the substrate. As illustrated in FIG. 12B, the aggregation box 100b, the aggregation box 100c, and the cover 140 include the connection detection circuits 114b, 114c, and 114x that detect whether they are connected to the aggregation box 100a, the aggregation box 100b, and the aggregation box 100c, respectively.

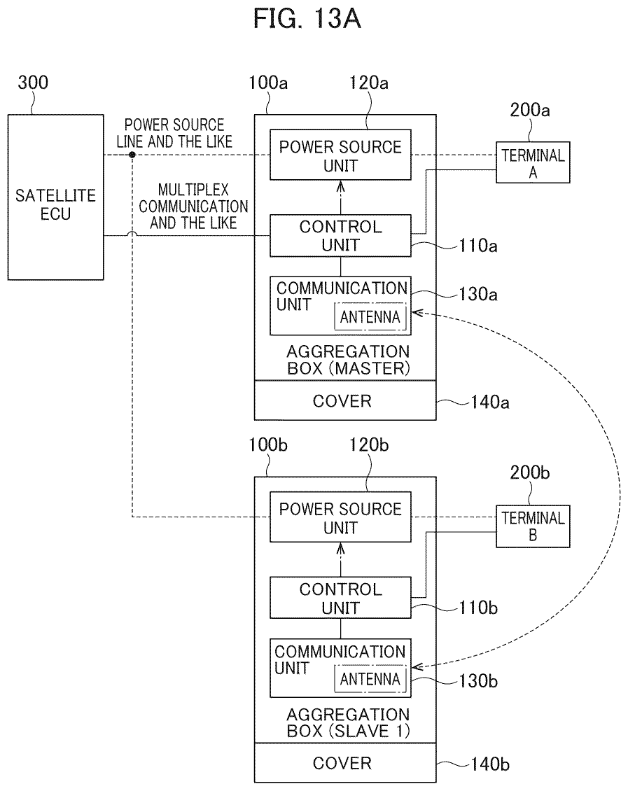

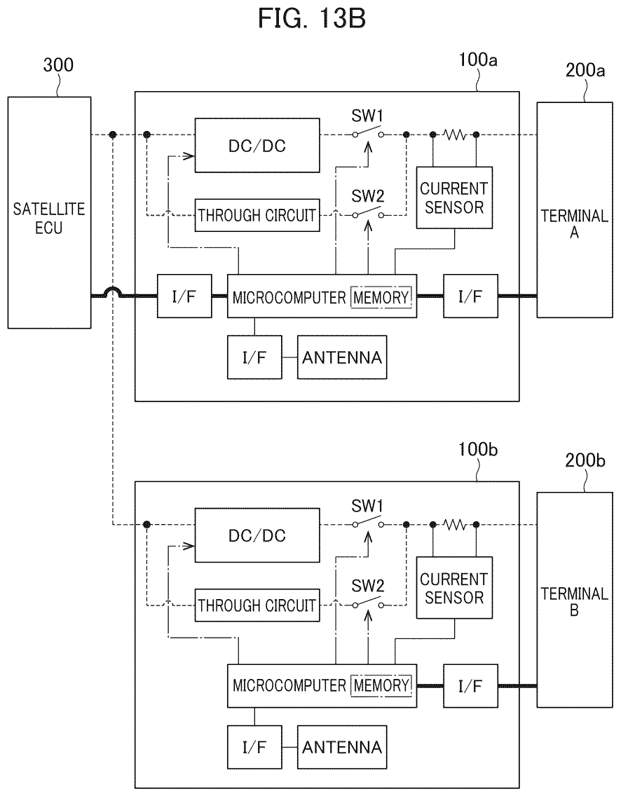

FIGS. 13A and 13B are diagrams for explaining another connection example of the aggregation box 100 according to the present embodiment. In the example illustrated in FIGS. 13A and 13B, communication is performed between the control unit 110a and the control unit 110b through the antennas of the communication unit 130a and the communication unit 130b.

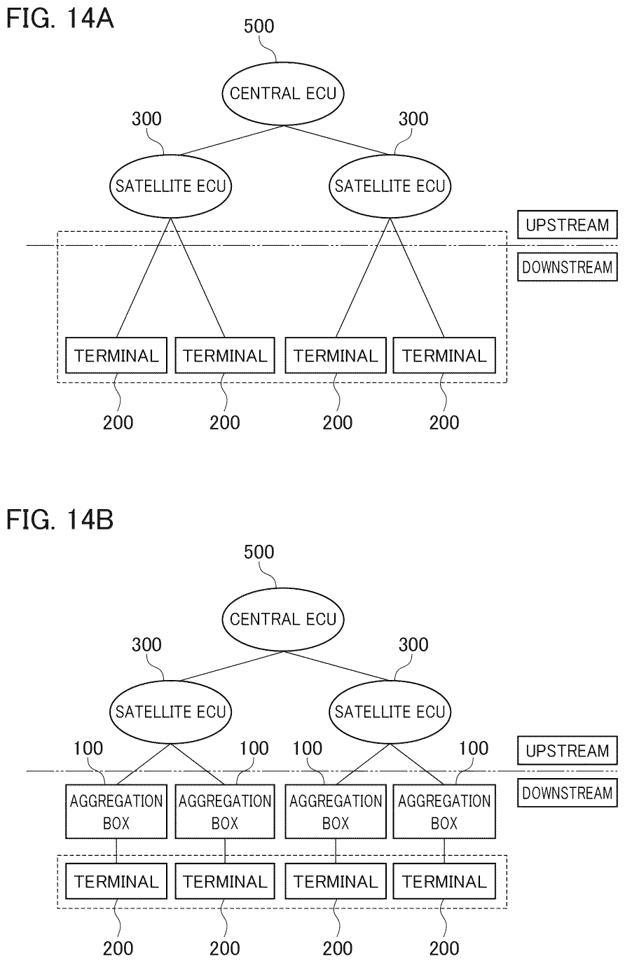

That is, in the in-vehicle system 10 according to the present embodiment, the connection as illustrated in FIGS. 9A to 13B facilitates the addition of the terminal device 200. Specifically, in the case of the comparative example illustrated in FIG. 14A, when the terminal device 200 is connected to the satellite ECU 300, a work area (in the dashed rectangle in FIG. 14A) is large, thereby making work such as cable routing for W/H difficult. In contrast, in the in-vehicle system 10 according to the present embodiment, as illustrated in FIG. 14B, the terminal device 200 can be connected to the aggregation box 100, and a work area (in the dashed rectangle in FIG. 14B) is small, thereby making work such as cable routing for W/H easy.

### Automation of Initial Setting of Aggregation Box 100

Next, automation of the initial setting of the aggregation box 100 will be described. In a configuration not using the aggregation box 100, the satellite ECU 300 and the terminal device 200 are directly connected to each other, and when adding the terminal device 200, the terminal device 200 that is anticipated in advance can be added.

However, in a configuration not using the aggregation box 100, when adding new functions, the distance between the satellite ECU 300 and the terminal device 200 is long, thereby making routing work difficult. Further, in a configuration not using the aggregation box 100, the terminal device 200 to be additionally connected needs to be anticipated in advance by the satellite ECU 300, thereby limiting the functions that can be added. Moreover, in a configuration not using the aggregation box 100, when configured with a 12 V power source system, a system other than the system operating at 12 V cannot be added.

The in-vehicle system 10 according to the present embodiment achieves efficient initial setting when adding the terminal device 200 by using the aggregation box 100.

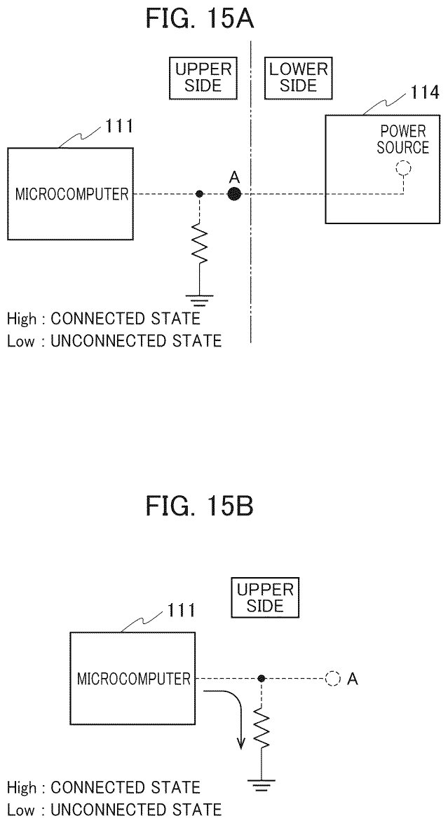

As illustrated in FIG. 9A, a plurality of aggregation boxes 100 can be connected and coupled, and when they are coupled, the cover 140 is connected to the terminal end of the aggregation box 100. Further, a circuit for detecting connection to the aggregation box 100 as illustrated in FIGS. 15A and 15B is provided inside the cover 140.

As illustrated in FIG. 15B, in the unconnected state, since the line at point A is connected to GND by a resistor, the potential becomes Low. In contrast, as illustrated in FIG. 15A, in the connected state, since the power source line is connected, the potential at point A becomes High.

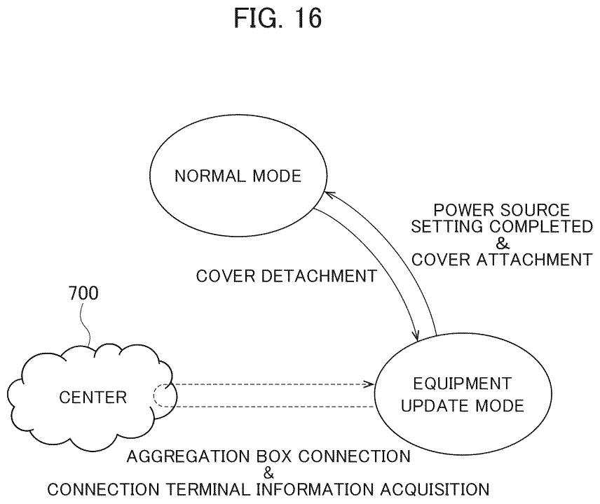

FIG. 16 is a diagram for explaining facility update in the in-vehicle system 10 according to the present embodiment. The aggregation box 100 can detect attachment and detachment of the cover 140. When the cover 140 is removed, the aggregation box 100 shifts to the equipment update mode, thereby enabling acquisition of the terminal connection information, and automatically transitions to the update mode. Further, when the cover 140 is attached and the power source setting is completed, the aggregation box 100 shifts to the normal mode.

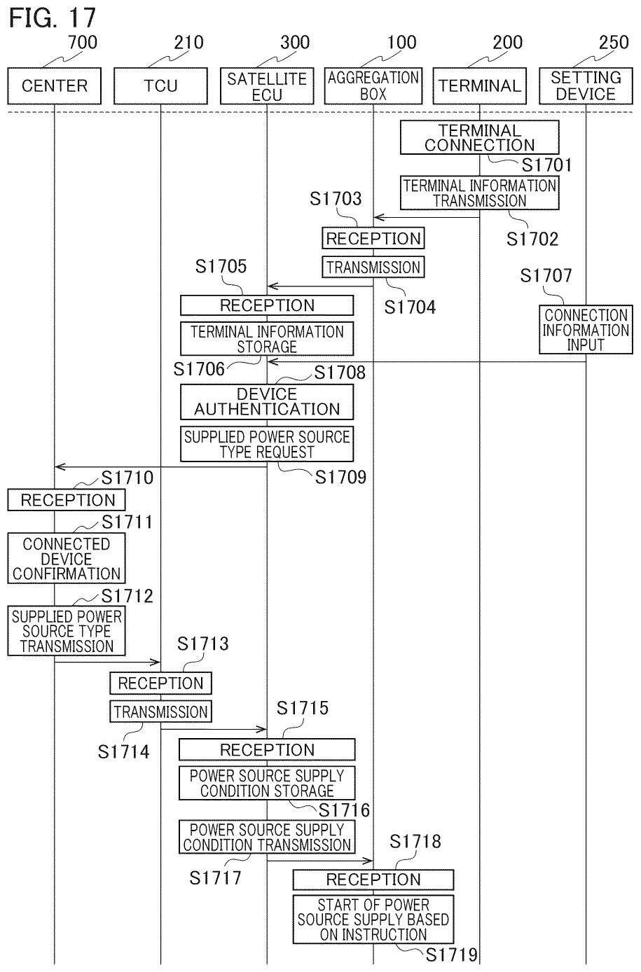

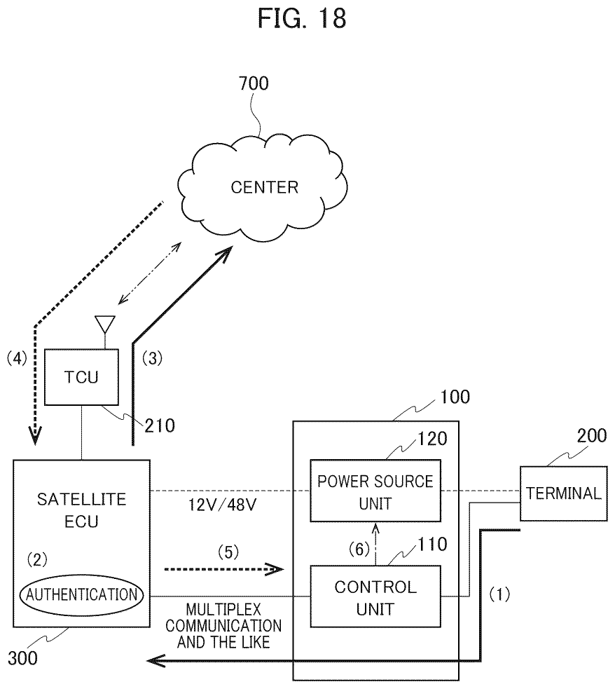

FIG. 17 is a sequence diagram for explaining communication and electric power supply in the in-vehicle system 10 according to the present embodiment. In addition, FIG. 18 is a diagram for explaining facility update in the in-vehicle system 10 according to the present embodiment.

In step S1701 of FIG. 17, the terminal device 200 is connected. Whether the terminal device 200 is connected is detected by the connection detection circuits 114b, 114c, and 114x illustrated in FIGS. 9B, 10B, 11B, and 12B.

In step S1702, the terminal connection information indicating that the terminal device 200 is connected is transmitted from the terminal device 200 to the aggregation box 100. The aggregation box 100 receives the terminal connection information transmitted from the terminal device 200 (step S1703) and transmits it to the satellite ECU 300 (step S1704, flow (1) of FIG. 18).

The satellite ECU 300 receives the terminal connection information transmitted from the aggregation box 100 (step S1705), and stores it in the storage unit (step S1706). In addition, the connection information is input from the setting device 250 (step S1707).

The satellite ECU 300 performs device authentication based on the terminal connection information and the connection information that is set in the setting device 250 (step S1708, processing (2) of FIG. 18). The satellite ECU 300 transmits the supplied power source type of the connected terminal device 200 to the center 700 via the TCU 210 (step S1709, flow (3) of FIG. 18).

The center 700 receives the information relating to the supplied power source type request (step S1710), and performs connected device confirmation (step S1711). Thereafter, the center 700 transmits the information relating to the supplied power source type which has been confirmed to the TCU 210 (step S1712). The TCU 210 receives the information relating to the supplied power source type (step S1713), and transmits it to the satellite ECU 300 (step S1714, flow (4) of FIG. 18).

The satellite ECU 300 receives the information relating to the supplied power source type (step S1715), and stores the power source supply condition (step S1716). Thereafter, the satellite ECU 300 transmits the power source supply condition to the aggregation box 100 (step S1717, flow (5) of FIG. 18).

The aggregation box 100 receives the power source supply condition (step S1718), and starts power source supply based on the instruction in the power source supply condition (step S1719, processing (6) of FIG. 18). Based on the processing illustrated in FIGS. 17 and 18, the in-vehicle system 10 can automate the initial setting of the terminal device 200.

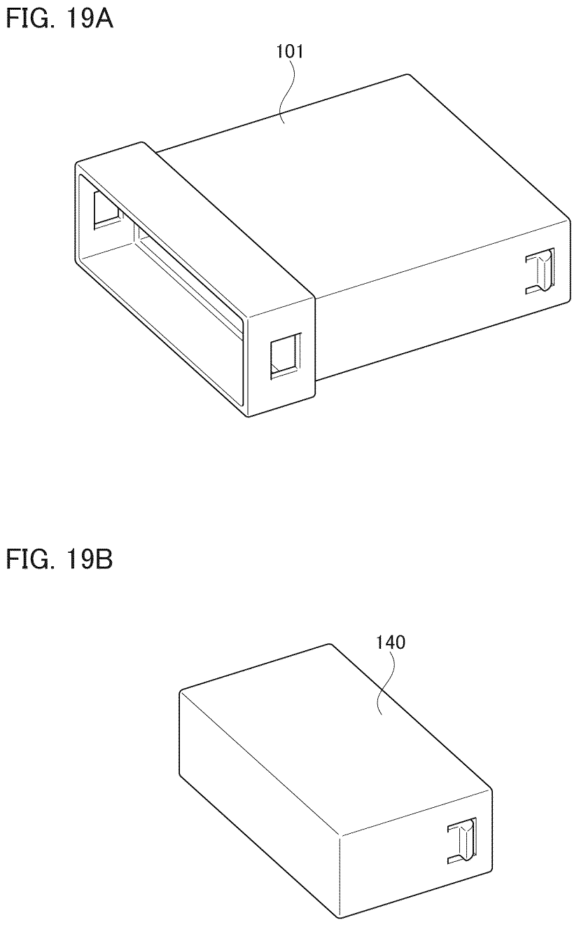

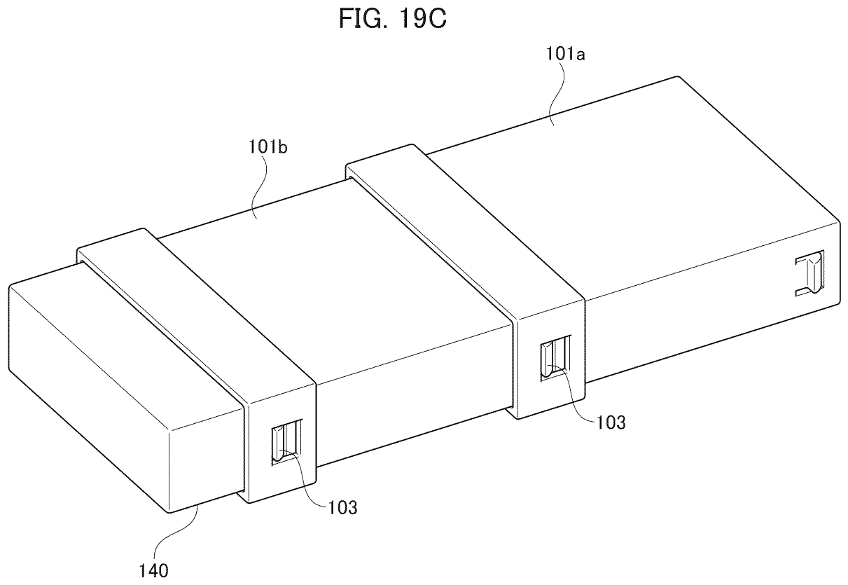

FIGS. 19A to 19C are diagrams for explaining a case 101 of the aggregation box 100 according to the present embodiment. FIG. 19A illustrates the case 101 that stores the aggregation box 100. FIG. 19B illustrates a cover 140 that is connected to the terminal end of the aggregation box 100. As illustrated in FIG. 19C, when the cases 101a and 101b of multiple aggregation boxes 100 and the cover 140 are connected, the case 101a, the case 101b, and the cover 140 can be fixed by the lock portions 103.

That is, the aggregation box 100 of the in-vehicle system 10 includes the connection detection circuit 114 that detects whether the terminal device 200 is connected. In addition, when the terminal device 200 is connected to the aggregation box 100, the satellite ECU 300 authenticates the terminal device 200 and transmits to the aggregation box 100 the information relating to the supplied power source type acquired via the external center 700. Moreover, the aggregation box 100 sets a voltage to be supplied to the terminal device 200 based on the information relating to the supplied power source type acquired from the satellite ECU 300. Thus, the in-vehicle system 10 can automate an initial setting of the terminal device 200.

### Configuration of TPMS 230 with Power Generation Function

Next, the TPMS 230 with a power generation function applied to the in-vehicle system 10 will be described. Among in-vehicle components, the failure rate of tires is about 30% on general roads and 50% or more on expressways. As the long-term use of vehicles advances, the failure rate of tires is predicted to increase further, so that a long-term usable tire pressure monitoring system (TPMS) capable of managing conditions and information of tires is required. In addition, a tire failure is directly linked to an accident, so that a more stable TPMS is required to improve safety and security.

Although a TPMS is attached to the tire valve to detect air pressure, a general TPMS cannot be used for a long time because it uses a primary battery. Therefore, in a general TPMS, the battery of the TPMS needs to be replaced together with the tire replacement. In addition, in a general TPMS, the battery cannot be replaced unless the tire is removed from the wheel, so that it is difficult to replace the battery of the TPMS at a desired timing.

Further, in a general TPMS, if the distance between the receiver and the TPMS is different, there is a difference in radio wave intensity, so that electric power consumption increases for stable communication. In addition, in a general TPMS, a failure caused by anything other than air pressure cannot be detected.

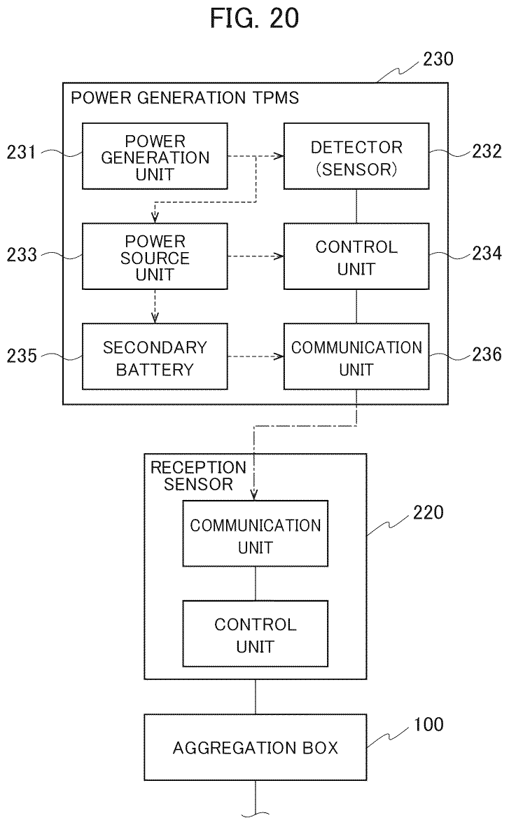

In the in-vehicle system 10 according to the present embodiment, the TPMS 230 with a power generation function which solves the above problems of a general TPMS is applied as the terminal device 200. FIG. 20 is a diagram for explaining the TPMS 230 applied to the in-vehicle system 10 according to the present embodiment.

As illustrated in FIG. 20, the TPMS 230 includes a power generation unit 231, a detector 232, a power source unit 233, a control unit 234, a communication battery 235, and a communication unit 236.

The power generation unit 231 generates necessary electric power by applying a power generation technology such as power generation by solar light, power generation by piezoelectric elements, or power generation by automatic winding used in a wristwatch. Therefore, the TPMS 230 does not need battery replacement, so that the TPMS 230 can be used for a long time.

The detector 232 detects information such as air pressure, travel distance, and tire usage time using a sensor. The information detected by the detector 232 and the other tire information are recorded by the control unit 234. The information relating to the TPMS 230, such as when it was installed, where it is used, and where it was made, is directly recorded by the user in the control unit 234.

The communication battery 235 is a rechargeable device such as a secondary battery or a capacitor that stores electricity generated by the power generation unit 231, and the stored electricity is used as communication electric power.

The communication unit 236 transmits the information detected by the detector 232 to a reception sensor 220. Since the TPMS 230 is attached to a wheel of each of the tires, the reception sensor 220 can be attached to the aggregation box 100 near the tires, and thus the reception sensor 220 can be easily added.

The conditions of tires are received by the reception sensor 220 and transmitted to a maintenance center 701 via the aggregation box 100 and the satellite ECU 300, and the information of the tires is managed by the maintenance center 701.

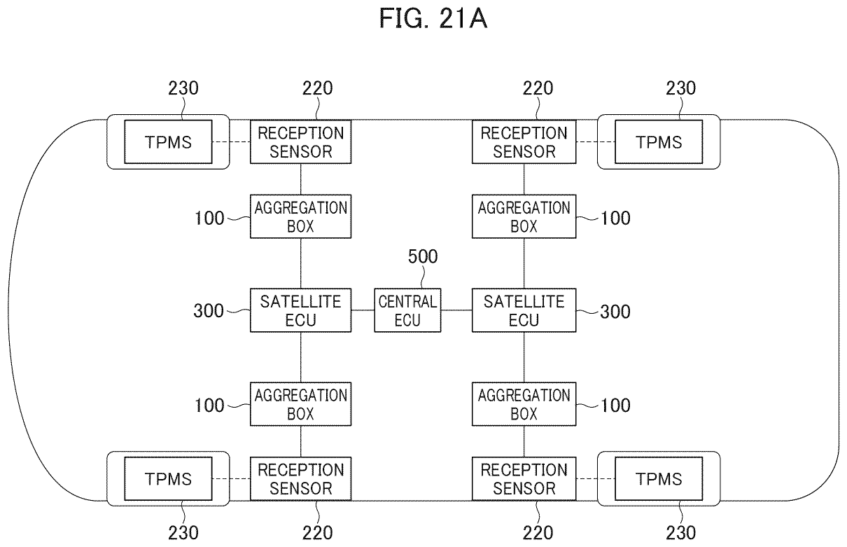

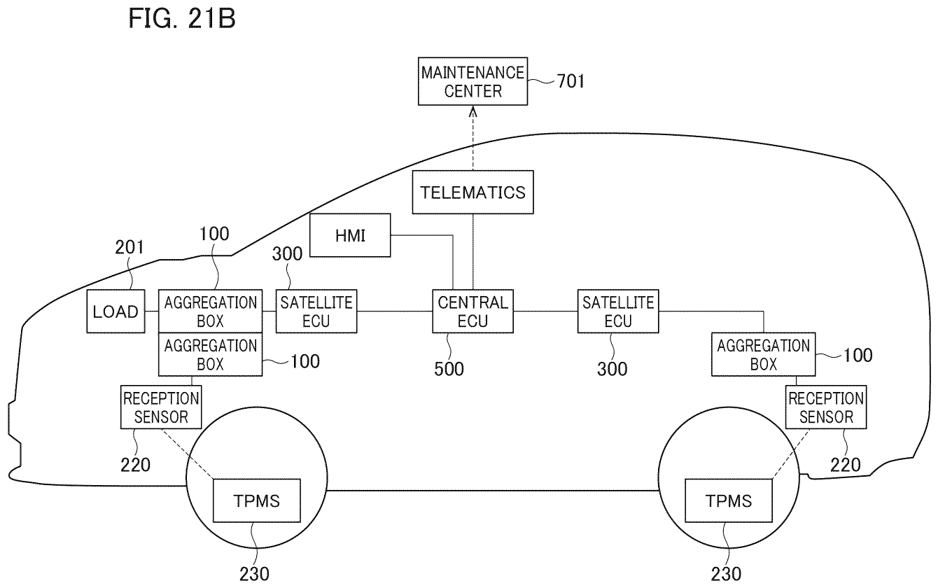

FIGS. 21A and 21B are diagrams illustrating an application example of the TPMS applied to the in-vehicle system 10 according to the present embodiment. In the in-vehicle system 10, the reception sensor 220 and the TPMS 230 can be positioned close to each other by the aggregation box 100, thereby making it possible to perform stable communication with less electric power. Further, the maintenance center 701 can manage the information of each tire, thereby making it possible to propose a rotation pattern and replacement of tires, and to manage the information on the used tires.

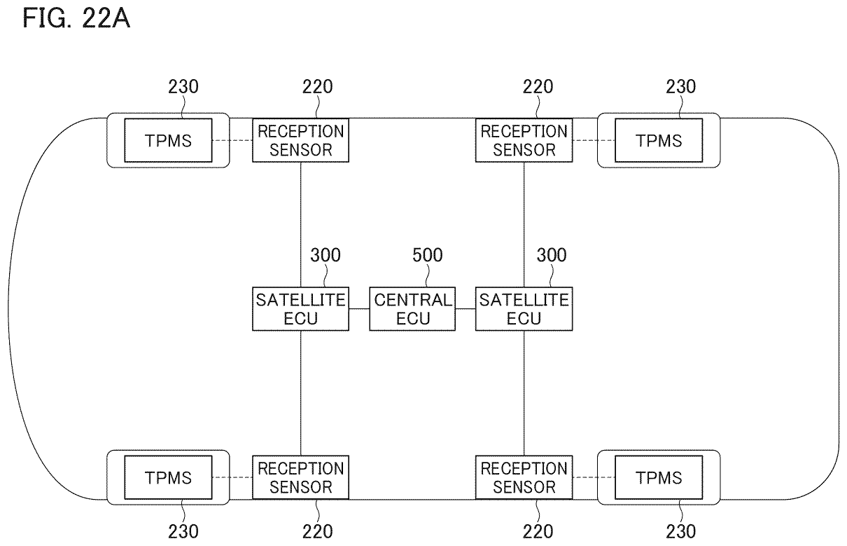

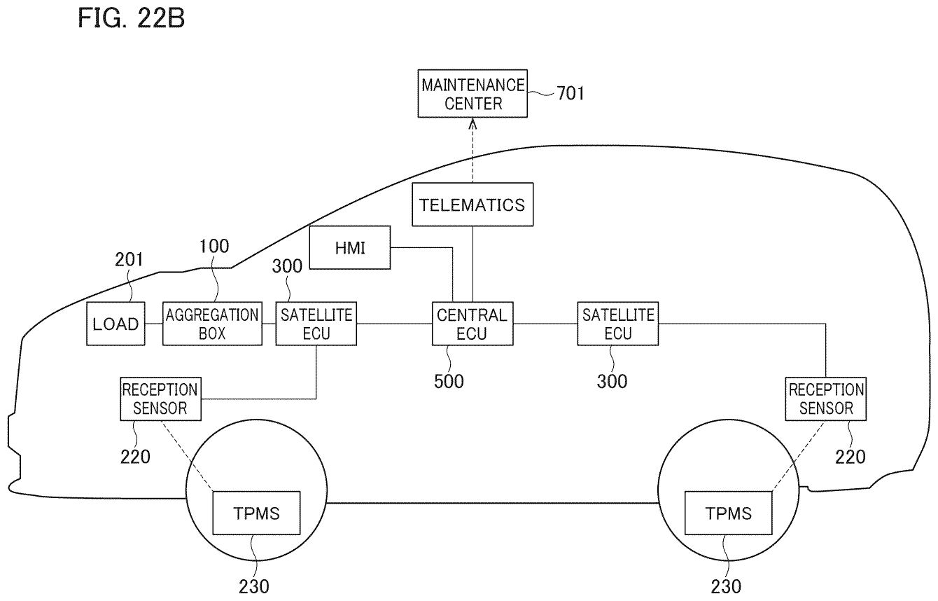

Note that, when the reception sensor 220 and the satellite ECU 300 can be connected to each other in advance, such as in new vehicles, the aggregation box 100 is not necessarily required (see FIGS. 22A and 22B).

The in-vehicle system 10 using the TPMS 230 according to the present embodiment can easily and reliably manage the conditions of tires. Further, in the in-vehicle system 10, the TPMS 230 can be used for a long period of time rather than as disposable units, thereby making it possible to contribute to reducing the introduction costs and environmental conservation. Further, in the in-vehicle system 10, by applying the aggregation box 100, the reception sensor 220 can be attached near the tires, and thus the communication distance can be shortened. Moreover, by managing the information using the maintenance center 701, it is possible to manage the information on the used tires and to support compliance with the digital passport under the ELV regulation.

### Driver Authentication System

Next, a driver authentication system applied to the in-vehicle system 10 according to the present embodiment will be described. With the progress of digitalization in the world, there has been consideration of the integration of a My Number Card and a driver's license, and of digitalization such that a personal certificate can be stored on a smartphone.

Meanwhile, in personal authentication in a vehicle, when a person enters the vehicle while holding a key such as a smart key, communication is performed between the smart key and the vehicle to verify the personal certificate (ID). By passing this verification, the ignition can be turned ON. For this reason, anyone can drive if he/she has a key. Thus, people such as “a person without a driver's license” or “a person who has acquired a key by illegal means” can drive a vehicle.

Therefore, there is a need for a driver authentication system using a certificate even in driving a vehicle. The driver authentication system applied to the in-vehicle system 10 according to the present embodiment realizes a system that performs personal authentication in a vehicle more reliably and is also applicable to various services.

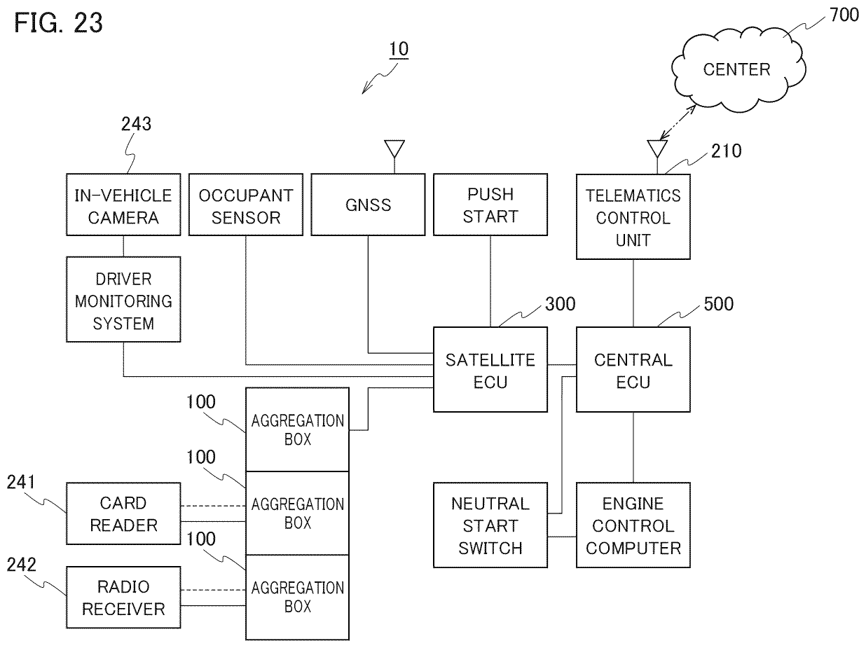

FIG. 23 is a diagram for explaining a driver authentication system applied to the in-vehicle system 10. As illustrated in FIG. 23, a card reader 241 and a radio receiver 242 are connected to the aggregation box 100.

The in-vehicle system 10 performs authentication (face authentication, age verification, expiration date verification) and violation history confirmation (confirmation of penalty points) using personal certificates such as a My Number Card and a driver's license, and an in-vehicle camera 243. Specifically, the in-vehicle system 10 accesses a database, which is provided in the satellite ECU 300, that manages information such as a driver's license and confirms the driver's driving history.

Further, for example, the in-vehicle system 10 makes it impossible to change the drive mode from the P range when the driver is changed while the ignition is ON and the driver authentication fails. However, the in-vehicle system 10 makes it possible to change the drive mode from the P range in an emergency such as when a vehicle emergency call system such as e-Call is activated or when an emergency switch is pressed.

Further, the in-vehicle system 10 periodically uploads not only the information of the personal certificate but also the driving status to the satellite ECU 300, thereby enabling the driver's usual driving skills to be monitored.

By using the aggregation box 100, the in-vehicle system 10 makes it possible to easily install the functions described above in a shared vehicle (for example, a car-sharing vehicle or a rental car) when needed and remove them when not needed, thereby enabling a minimum set of devices to be used repeatedly across multiple vehicles.

Next, processing of the driver authentication system applied to the in-vehicle system 10 will be described. First, a driver enters a vehicle and inserts a personal information card (such as a driver's license) into the card reader 241. Next, the card reader 241 reads out the personal information and acquires personal information data. Further, the in-vehicle camera 243 captures the driver's face and acquires the face data.

The satellite ECU 300 matches the acquired personal information data with the face data. If there is no problem in the matching result, the satellite ECU 300 notifies the smart key computer of authentication. If there is a problem in the matching result, the satellite ECU 300 notifies the smart key computer of non-authentication and repeatedly checks the driver a certain number of times.

The driver authentication system applied to the in-vehicle system 10 according to the present embodiment improves the accuracy of driver authentication, thereby obtaining an effect in measures against vehicle theft and driving without a license. In addition, by using the information of personal authentication by the card reader 241 and the face information of the driver acquired by the in-vehicle camera 243, it is possible to receive online medical care services in the vehicle.

In addition, since the in-vehicle system 10 can access a database, which is provided in the satellite ECU 300, that manages information such as a driver's license and confirm a driver's driving history, it is possible to contribute to accident prevention and environmental conservation by raising awareness of safe driving and eco-friendly driving.

In addition, the in-vehicle system 10 can be used for various services by verifying and uploading information such as driving history by cloud connection.

In addition, the in-vehicle system 10 makes it easy to attach and detach a set of devices by applying the aggregation box 100, thereby making it possible to use the set repeatedly across multiple vehicles. Therefore, it is not necessary to purchase a new set when changing vehicles, which contributes to reduction of introduction costs and waste reduction.

In addition, the in-vehicle system 10 can easily be additionally provided with a system that ensures safety by updating the satellite ECU 300. Further, by using the aggregation box 100, the in-vehicle system 10 can be provided in a vehicle only when necessary (for a limited period).

As described above, the aggregation box 100 is provided between an ECU and a power source, which are mounted on a vehicle, and the terminal device 200, relays data exchanged between the ECU and the terminal device 200, and supplies electric power supplied from the power source to the terminal device 200. The aggregation box 100 includes the power source unit 120 that switches a voltage value of the electric power supplied from the power source according to input voltage specifications of the terminal device 200 to be connected, and supplies the electric power to the terminal device 200. Further, the aggregation box 100 includes the control unit 110 that relays the data and controls switching of a voltage value in the power source unit 120. Further, the aggregation box 100 includes the connection connector 102 for connecting to another aggregation box 100, the connection connector 102 including signal terminals for transmitting and receiving the data and power source terminals for supplying the electric power. Note that the ECU connected to the aggregation box 100 corresponds to the satellite ECU 300. In addition, the power source connected to the aggregation box 100 corresponds to the downstream power source box 400.

Thus, in the aggregation box 100, not only in-vehicle devices which are anticipated to be added at the time of vehicle sale but also in-vehicle devices which are not anticipated to be added at the time of vehicle sale can be easily added.

Further, in the in-vehicle system 10, the ECU and the aggregation box 100, and the aggregation box 100 and the terminal device 200 may be connected by a cylindrical or flat cable routing material, an optical fiber, a coaxial cable, or a cable routing material formed of a balanced communication cable. Thus, the in-vehicle system 10 can apply cable routing materials corresponding to the functions and installation positions of the ECU, the aggregation box 100, and the terminal device 200.

Further, in the in-vehicle system 10, the wire length of the cable routing material used for connecting the ECU and the aggregation box 100 may be longer than the wire length of the cable routing material used for connecting the aggregation box 100 and the terminal device 200. Thus, the in-vehicle system 10 can reduce the amount of the cable routing material to be replaced in the attachment of the terminal device 200.

Further, the aggregation box 100 of the in-vehicle system 10 may include the connection detection circuit 114 that detects whether the terminal device 200 is connected. In addition, when the terminal device 200 is connected to the aggregation box 100, the ECU may authenticate the terminal device 200 and transmit to the aggregation box 100 the information relating to the supplied power source type acquired via the external center 700. Moreover, the aggregation box 100 may set a voltage to be supplied to the terminal device 200 based on the information relating to the supplied power source type acquired from the ECU. Thus, the in-vehicle system 10 can automate an initial setting of the terminal device 200.

Further, the terminal device 200 may be the TPMS 230 (tire pressure monitoring system) with a power generation function. Thus, the in-vehicle system 10 can easily and reliably manage the conditions of tires. Further, in the in-vehicle system 10, the TPMS 230 can be used for a long period of time rather than as disposable units, thereby making it possible to contribute to reducing introduction costs and environmental conservation. Further, in the in-vehicle system 10, by applying the aggregation box 100, the reception sensor 220 can be attached near the tires, and thus the communication distance can be shortened.

Further, the in-vehicle system 10 may further include the in-vehicle camera 243 that captures a driver's face. In addition, the terminal device 200 may include the card reader 241 that reads out personal information in which personal information of the driver is stored. Moreover, the ECU may authenticate the driver based on the face data of the driver captured by the in-vehicle camera 243 and the personal information data acquired by the card reader 241.

Thus, the in-vehicle system 10 improves the accuracy of driver authentication using the driver authentication system, thereby obtaining an effect in measures against vehicle theft and driving without a license. Further, by using the information of personal authentication by the card reader 241 and the face information of the driver acquired by the in-vehicle camera 243, it is possible to receive online medical care services in the vehicle.

### Other Embodiments

Although the embodiment has been described in detail with reference to the drawings, the present embodiment is not limited by the contents described in the above embodiment. Moreover, the above components include those that can be easily anticipated by a person skilled in the art and those that are substantially the same. Furthermore, the above components can be combined appropriately. In addition, various omissions, replacements, or changes of the configuration can be made without departing from the gist of the embodiment.

When the communication capacity of the data exceeds a predetermined threshold value due to addition of the terminal device 200, the aggregation box 100 of the in-vehicle system 10 according to the above embodiment may be configured to communicate with the ECU via another aggregation box 100. In the present embodiment, the predetermined threshold value is a value that is predetermined in advance and may be, for example, 80% of the communication capacity. Note that the predetermined threshold value is not limited to the configuration of the present embodiment and may be a value greater or less than 80%. According to this configuration, the in-vehicle system 10 can realize a system capable of large-capacity and high-speed communication by using another aggregation box 100 to increase the efficiency of communication.

The features of the aggregation box 100 and the in-vehicle system 10 will be described below.

The aggregation box 100 according to the first aspect is provided between an ECU and a power source, which are mounted on a vehicle, and the terminal device 200, relays data exchanged between the ECU and the terminal device 200, and supplies electric power supplied from the power source to the terminal device 200. The aggregation box 100 includes the power source unit 120 that switches a voltage value of the electric power supplied from the power source according to input voltage specifications of the terminal device 200 to be connected, and supplies the electric power to the terminal device 200. Further, the aggregation box 100 includes the control unit 110 that relays the data and controls switching of a voltage value in the power source unit 120. Further, the aggregation box 100 includes the connection connector 102 for connecting to another aggregation box 100, the connection connector 102 including signal terminals for transmitting and receiving the data and power source terminals for supplying the electric power. Note that the ECU connected to the aggregation box 100 corresponds to the satellite ECU 300. In addition, the power source connected to the aggregation box 100 corresponds to the downstream power source box 400.

According to the above configuration, in the aggregation box 100, not only in-vehicle devices which are anticipated to be added at the time of vehicle sale but also in-vehicle devices which are not anticipated to be added at the time of vehicle sale can be easily added.

The in-vehicle system 10 according to the second aspect includes the ECU mounted on the vehicle, the power source mounted on the vehicle, and the terminal device 200 mounted on the vehicle. Further, the in-vehicle system 10 includes the above aggregation box that is provided between the ECU and the power source, and the terminal device 200, relays data exchanged between the ECU and the terminal device 200, and supplies the electric power supplied from the power source to the terminal device 200.

According to the above configuration, in the in-vehicle system 10, in-vehicle devices which are not anticipated at the time of vehicle sale can be easily added.

In the in-vehicle system 10 according to the third aspect, the ECU and the aggregation box 100, and the aggregation box 100 and the terminal device 200 may be connected by a cylindrical or flat cable routing material, an optical fiber, a coaxial cable, or a cable routing material formed of a balanced communication cable.

According to the above configuration, the in-vehicle system 10 can apply cable routing materials corresponding to the functions and installation positions of the ECU, the aggregation box 100, and the terminal device 200.

In the in-vehicle system 10 according to the fourth aspect, the wire length of the cable routing material used for connecting the ECU and the aggregation box 100 may be longer than the wire length of the cable routing material used for connecting the aggregation box 100 and the terminal device 200.

According to the above configuration, the in-vehicle system 10 can reduce the amount of the cable routing material to be replaced in the attachment of the terminal device 200.

Further, the aggregation box 100 of the in-vehicle system 10 according to the fifth aspect may include the connection detection circuit 114 that detects whether the terminal device 200 is connected. In addition, when the terminal device 200 is connected to the aggregation box 100, the ECU may authenticate the terminal device 200 and transmit to the aggregation box 100 the information relating to the supplied power source type acquired via the external center 700. Moreover, the aggregation box 100 may set a voltage to be supplied to the terminal device 200 based on the information relating to the supplied power source type acquired from the ECU.

According to the above configuration, the in-vehicle system 10 can automate an initial setting of the terminal device 200.

The terminal device 200 of the in-vehicle system 10 according to the sixth aspect may be the TPMS 230 (tire pressure monitoring system) with a power generation function.

According to the above configuration, the in-vehicle system 10 can easily and reliably manage the conditions of tires. Further, in the in-vehicle system 10, the TPMS 230 can be used for a long period of time rather than as disposable units, thereby making it possible to contribute to reducing introduction costs and environmental conservation. Further, in the in-vehicle system 10, by applying the aggregation box 100, the reception sensor 220 can be attached near the tires, and thus the communication distance can be shortened.

The in-vehicle system 10 according to the seventh aspect may further include the in-vehicle camera 243 that captures a driver's face. In addition, the terminal device 200 may include the card reader 241 that reads out personal information data in which personal information of the driver is stored. Moreover, the ECU may authenticate the driver based on the face data of the driver captured by the in-vehicle camera 243 and the personal information data acquired by the card reader 241.

According to the above configuration, the in-vehicle system 10 improves the accuracy of driver authentication using the driver authentication system, thereby obtaining an effect in measures against vehicle theft and driving without a license. Further, by using the information of personal authentication by the card reader 241 and the face information of the driver acquired by the in-vehicle camera 243, it is possible to receive online medical care services in the vehicle.

When the communication capacity of the data exceeds a predetermined threshold value due to addition of the terminal device 200, the aggregation box 100 of the in-vehicle system 10 according to the eighth aspect may communicate with the ECU via another aggregation box 100.

According to the above configuration, the in-vehicle system 10 can realize a system capable of large-capacity and high-speed communication by using another aggregation box 100 to increase the efficiency of communication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An aggregation box that is provided between an ECU and a power source, which are mounted on a vehicle, and a terminal device, relays data exchanged between the ECU and the terminal device, and supplies electric power supplied from the power source to the terminal device, the aggregation box comprising:
a power source unit that switches a voltage value of the electric power supplied from the power source according to input voltage specifications of the terminal device to be connected, and supplies the electric power to the terminal device;
a control unit that relays the data and controls switching of a voltage value in the power source unit; and
a connection connector for connecting to the other aggregation box, the connection connector including signal terminals for transmitting and receiving the data and power source terminals for supplying the electric power.

2. An in-vehicle system comprising:
the ECU mounted on a vehicle;
the power source mounted on the vehicle;
the terminal device mounted on the vehicle; and
the aggregation box of claim 1 that is provided between the ECU and the power source, and the terminal device, relays the data exchanged between the ECU and the terminal device, and supplies the electric power supplied from the power source to the terminal device.

3. The in-vehicle system of claim 2, wherein
the ECU and the aggregation box, and the aggregation box and the terminal device are connected by a cylindrical or flat cable routing material, an optical fiber, a coaxial cable, or a cable routing material formed of a balanced communication cable.

4. The in-vehicle system of claim 3, wherein
a wire length of the cable routing material used for connecting the ECU and the aggregation box is longer than a wire length of the cable routing material used for connecting the aggregation box and the terminal device.

5. The in-vehicle system of claim 2, wherein
the aggregation box includes a connection detection circuit that detects whether the terminal device is connected,
when the terminal device is connected to the aggregation box, the ECU authenticates the terminal device and transmits to the aggregation box information relating to a supplied power source type acquired via an external center, and
the aggregation box sets a voltage to be supplied to the terminal device based on the information relating to the supplied power source type acquired from the ECU.

6. The in-vehicle system of claim 2, wherein
the terminal device is a TPMS (tire pressure monitoring system) with a power generation function.

7. The in-vehicle system of claim 2, further comprising:
an in-vehicle camera that captures a driver's face, wherein
the terminal device includes a card reader that reads out personal information data in which personal information of the driver is stored, and
the ECU authenticates the driver based on face data of the driver captured by the in-vehicle camera and the personal information data acquired by the card reader.

8. The in-vehicle system of claim 2, wherein
when communication capacity of the data exceeds a predetermined threshold value due to addition of the terminal device, the aggregation box communicates with the ECU via the other aggregation box.
